(19) United States
(12) Patent Application Publication
(10) Pub. No.: US 2017/0087047 A1
(43) Pub. Date: Mar. 30, 2017

(54) MASSAGE HEAD AND MASSAGE APPARATUS USING SUCH A HEAD

(71) Applicant: LPG SYSTEMS, Valence (FR)

(72) Inventor: Arnaud Fuster, Beaumont Les Valence (FR)

(73) Assignee: LPG SYSTEMS, Valence (FR)

(21) Appl. No.: 15/306,716

(22) PCT Filed: Apr. 17, 2015
(86) PCT No.: PCT/FR2015/051042

§ 371 Date: Oct. 25, 2016

(30) Foreign Application Priority Data
Jun. 6, 2014 (FR) 1455162

(51) Int. Cl. A61H 15/00

(52) U.S. Cl. CPC A61H 15/0078; A61H 2201/1215

(57) ABSTRACT

A massage head including a casing forming an internal chamber defined by a back wall, two lateral walls, and two transverse walls, and open on its surface opposite to the back wall, and having a skinfold formed therein when the head is applied to a patient's skin. The head is formed of two modules provided with means capable of enabling to reversibly fasten them to each other. Each of the modules integrates a functional element defining one of the transverse walls of the internal chamber.

### TECHNOLOGICAL FIELD

The present invention relates to an advanced massage head, generally intended for mobilizing the skin tissue.

It also relates to a massage apparatus using such a head.

The object of the presently described embodiments mainly is to enable to multiply the possible actions of such a massage head according to the result desired by the practitioner. To achieve this, the massage head according to the described embodiments comprises two modules capable of being reversibly fastened to each other, each of the modules integrating a functional element.

### BACKGROUND

Different massaging techniques are know, their implementation depending on the treatments to be performed. Generally, such techniques aim at exerting on the patient's skin actions using pressure and/or pinching phenomena on skin tissue.

A large number of devices have been provided to make the practitioner's action easier. Among such devices, the use of devices using a simple mechanical action, for example, by means of assemblies comprises balls assembled on a support casing, possibly enabling to distribute or to simultaneously apply a treatment product of cream or gel type such as for example described in document FR A 1 225 094, have first been provided.

It has also been provided to replace this mechanical treatment with a treatment of suction of the patient's skin. To achieve this, the concerned massaging apparatuses use a treatment head connected to a suction circuit, said treatment head being formed of a casing defining an internal chamber having the suction circuit emerging into it. When the massage head is applied against the patient's body, and due to the suction generated by the suction circuit, a skinfold forms within the internal chamber. The mechanical action may be exerted by rollers or balls which enable to exert, simultaneously to the suction on the patient's body, a pressure and/or displacement and/or friction action, particularly by vibrations.

Massage apparatuses capable of simply reproducing subdermal-tissue-type massages, that is, exerting a continuous action on the patient, causing not only a local pinching of the skin tissue, but also a progressive displacement of the pinched area to cause a rolling of said skinfold and, this, while exerting a pressure (see, for example, EP-A-0 224 422), have already been provided.

The apparatuses described, for example, in this document, comprise a manually-actuatable casing having two parallel rollers, assembled to freely rotate or positively rotated within the casing, assembled therein. The rollers may be assembled on the casing with a fixed center-to-center distance, or are conversely capable of automatically moving away and coming closer to each other during the massage operation, said casing being itself connected to suctions means enabling to create a depression between said rollers when the head provided between these different elements is applied against the patient's body, to form a skinfold bearing against the roller surface.

In document EP 0 917 452, it has been provided to replace the rollers with two partition walls placed inside of the casing, hinged inside thereof to be able to have a pivoting motion. Said casing is, here again, connected to a suction source. Under the action of the suction, a skinfold is created, which inserts between the two partition walls inside of the casing. Due to the progress in one direction or the other of the massage head fitted with such a device against the patient's skin, the skinfold thus formed is submitted to a jerky pinching.

In the absence of action, the two partition walls are maintained spaced apart from each other, for example, by means of springs or of magnets, the pivoting of said partition walls and thus their coming together resulting from the effect of vacuum and/or of the depression generated inside of the casing.

These different devices provide quite satisfactory results. However, usage demonstrates that they do not enable, as such, to have the entire equipment necessary for the different treatments that a practitioner may wish to apply to a patient. Indeed, either such devices comprise two motor-driven or freely-rotating rollers, with a fixed center-to-center distance or capable of drawing away or of coming closer to each other, or partition walls or flaps carrying out a massaging-pinching action, but none of them enables to simultaneously obtain a subdermal tissue massaging action with a massaging-pinching action, unless the massage heads are interchanged, which thus requires having a plurality of such heads.

The presently described embodiments thus aim at optimizing the possible treatment types, and particularly at providing a hybrid head to meet this need.

### SUMMARY

For this purpose, a massage head comprising a casing forming an internal chamber defined by a back wall, two lateral walls, and two transverse walls, and open on its surface opposite to the back wall, and where a skinfold is formed when the head is applied to a patient's skin.

According to the presently described embodiments, the massage head is formed of two modules fitted with means capable of enabling them to be reversibly fastened to each other, each of said modules integrating a functional element, defining one of the transverse walls of the internal chamber.

In other words, the embodiments described herein provide a massage head formed of two independent modules, their association with each other defining the internal chamber within which the skinfold is formed, and providing each of the modules with an identical or different functional element, thus capable of optimizing the carrying out of the treatment on the patient's skin.

According to the presently described embodiments, one at least of the functional elements fitting each of the modules is active. “Active” means that said element is animated by a movement, either pivoting or rotating, and is in the case in point either a flap, or a roller.

When it is a flap, it may be motor-driven, said flap being hinged in the vicinity of its upper end on the lateral walls of the module and its pivoting movement is obtained by means of a geared reducer fixedly assembled within said flap, and having its output shaft rotating a cam, received in a cam race fastened to one of said lateral walls of the module.

When it is a roller, it is motor-driven, that is, the roller is positively rotated, the rotation being here again obtained by means of a geared motor fixedly assembled inside of the roller and having its output shaft comprising means of coupling to said roller.

According to the presently described embodiments, one of the functional elements may be a fixed flap or wall, in that it has not pivoting movement within the module, and thus within the internal chamber that it defines when it is fastened to another module.

According to the presently described embodiments, one of the functional elements may be made of a roller simply assembled to freely rotate, with a fixed center-to-center distance.

According to an advantageous feature, said modules define, when they are reversibly fastened to each other, the back wall of the internal chamber and form an opening into which a suction circuit, connected to the massage apparatus having the massage head described herein assembled thereon, emerges.

The presently described embodiments also relate to a massage device using a massage head according to the foregoing description, comprising an electric power source capable of actuating the functional elements when they are active, and advantageously comprising a vacuum or depression source associated with the massage head and emerging into it.

### BRIEF DESCRIPTION OF THE DRAWINGS

The way in which the massage head and massage device may be implemented and the resulting advantages will better appear from the following non-limiting embodiments, in relation with the accompanying drawings.

FIGS. 1 to 5 schematically illustrate the general principles described herein.

FIGS. 6 and 7 are simplified sagittal section views of a first embodiment of the massage head using motor-driven flaps, respectively at rest and in action.

FIGS. 8 and 9 are simplified sagittal section views of a second embodiment of the massage head using respectively a motor-driven flap and a fixed wall, respectively in static position and in active position.

FIGS. 10 and 11 are simplified sagittal section views of a third embodiment using, on the one hand, a motor-driven flap and, on the other hand, a motor-driven roller, respectively in static position and in operating position.

FIGS. 12 and 13 are simplified sagittal section views of a fourth embodiment of the massage head using two motor-driven rollers, respectively in static and functional position.

FIGS. 14 and 15 are simplified sagittal section views of a fifth embodiment of the massage head using two motor-driven rollers, one of which is hinged.

FIGS. 16 and 17 are simplified sagittal section views of a sixth embodiment of the massage head using two hinged motor-driven rollers.

FIGS. 18 to 21 schematically illustrate a motor-driven flap.

FIGS. 22 to 25 schematically illustrate a motor-driven roller, and respectively depict exploded perspective views showing the general structure of a motor-driven roller usable to form a massage head, an end view of such a massage roller, and a cross-section view along plane AA crossing the rotation shaft of said roller lengthwise.

### DETAILED DESCRIPTION

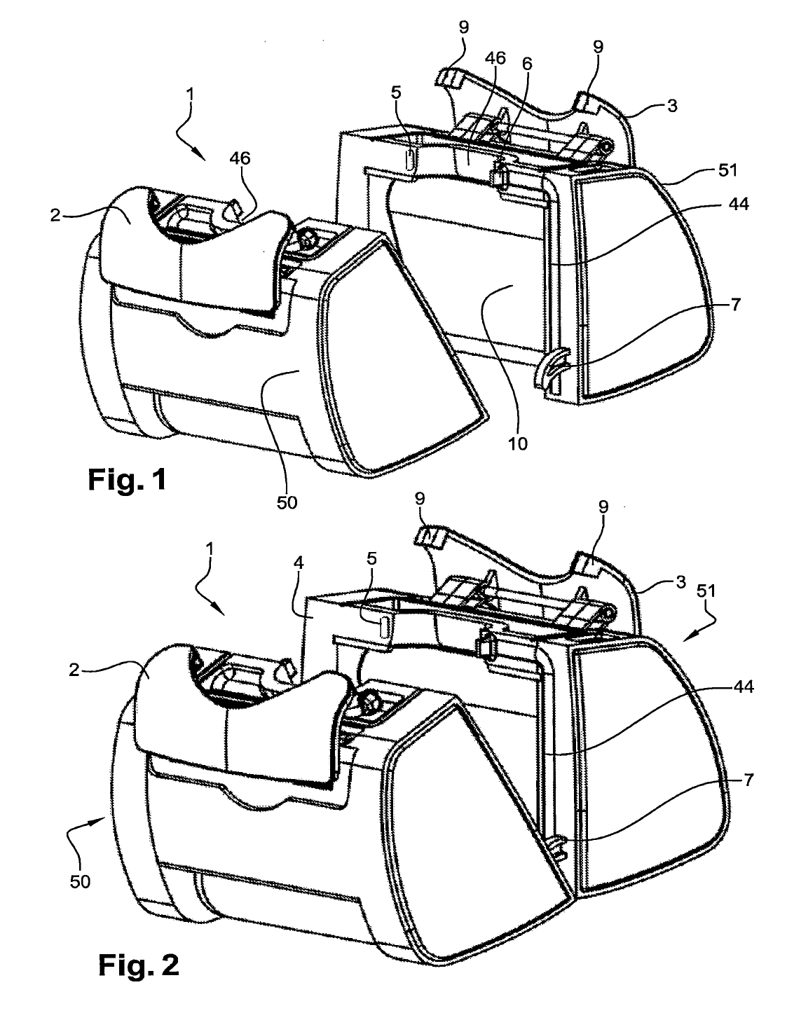

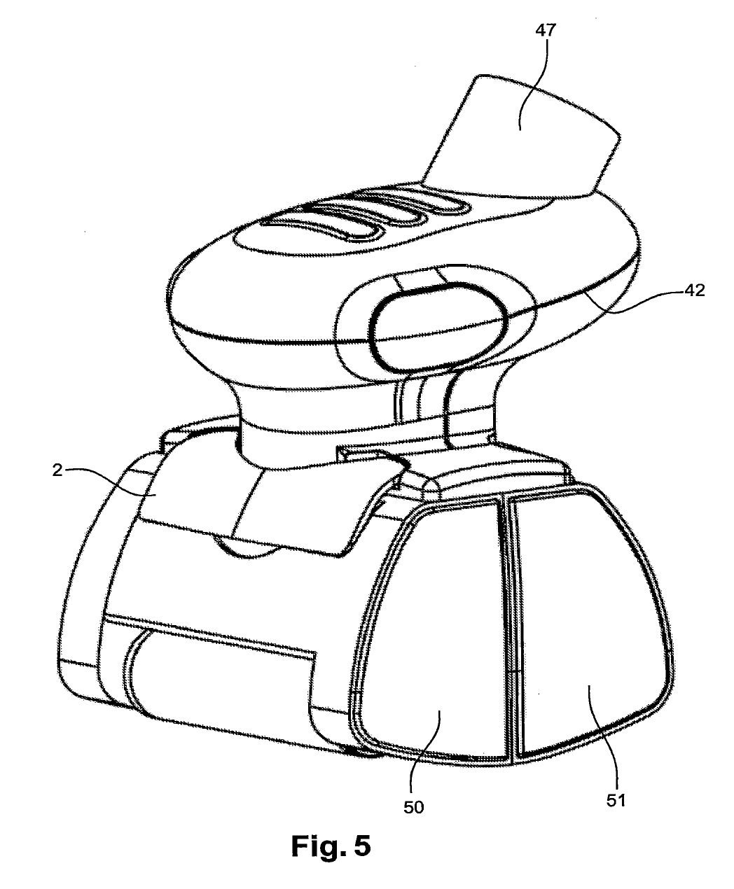

FIGS. 1 to 5 illustrate the general principle of the embodiments described herein. In the case in point, they describe a massage head 1 formed of two modules 50, 51, substantially symmetrical to each other with respect to a median plane, to within the functional element integrated in each of the modules.

To ensure such a reversible fastening of a module 50, 51 with the other, each of them has, at the level of its front surface 4, protruding members or lugs 6, 7 and recessed members 5, 8 intended to cooperate two-by-two with one another.

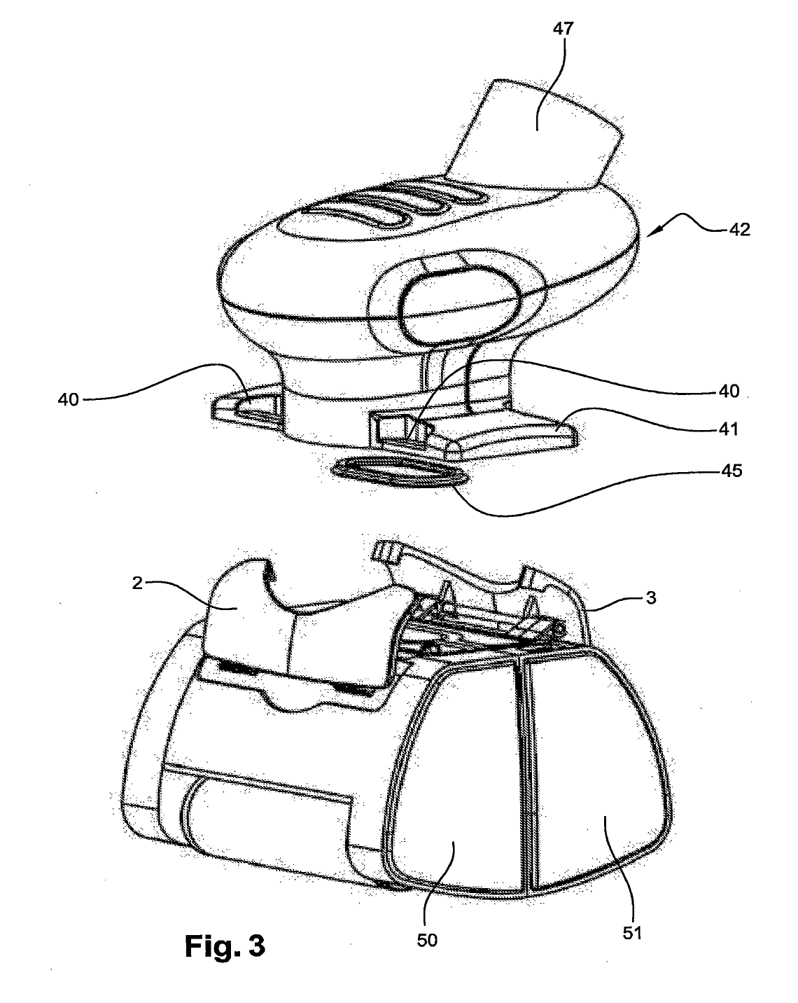

Further, each module 50, 51 is provided with a locking device or flap 2, 3, hinged in the vicinity of the upper end of said modules. Each of the locking devices or flaps is itself provided with two tabs 9, capable of snapping into a housing or locking area 40 provided for this purpose at the level of base 41 of upper portion 42 of the massage head (see FIG. 3).

When the two modules 50, 51 are desired to be assembled together, according to the nature of the functional element (see below) integrated in each of them, the lugs 7 fitting each of them are inserted into the corresponding housing 8 (FIG. 2), after which the two front surfaces 4 of the two modules are pressed against each other (FIG. 3), the alignment lugs 6 of each of said modules lodging themselves into the corresponding recess 5.

Said front surfaces 4 being provided with a sealing gasket 44, this provides some tightness in the internal chamber defined by the assembly of the two modules together.

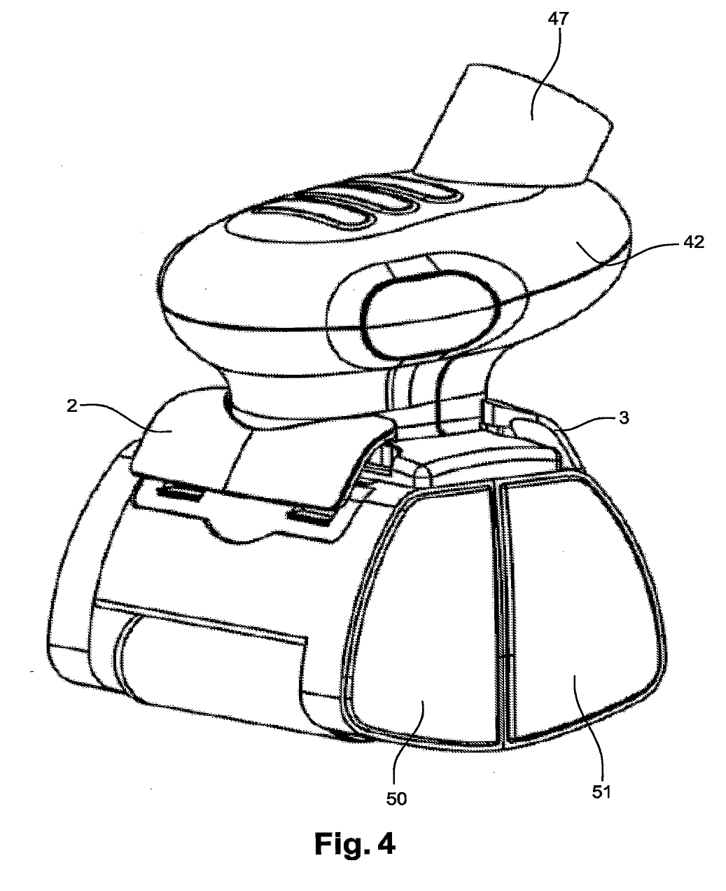

Base 41 of upper portion 42 of the massage head is then positioned on the upper surface defined by the two upper surfaces of the modules thus assembled. Said base 41 is locked on the modules thus assembled, by pivoting and locking of locking flaps or hoods 2, 3 in locking areas 40 of base 41 (FIGS. 4 et 5). The lower surface of base 41 is provided with a sealing gasket 45, which positions at the periphery of opening 52 defined by recesses 46 formed at the level of the upper surfaces of the modules when they are assembled together. This opening is intended to enable to place the internal chamber defined by said modules under a low pressure, by connection with a depression source relayed by a pipe 47 fitting the upper portion of the massage chamber, said depression source being integrated in the massage device using this massage head.

The depression source is capable of generating a suction within the internal chamber thus defined when the massage head is applied to a patient's skin.

Thus, when the two modules are assembled, they form an internal chamber of the massage head. The internal chamber is defined by two lateral walls, two transverse walls, and a back wall. The surface opposite to the back wall is open, and is meant to come into contact with a patient's skin.

Each of the modules integrates an active or passive functional element.

This functional element actually forms one of the transverse walls of the internal chamber. In the case in point, the functional element may be formed:

of a flap, fixed 53 or motor-driven 10;

of a roller formed at the lower end of a transverse wall, said roller being freely rotating or motor-driven 100.

Thereby, it becomes possible to form all sorts of possible configurations of the massage head.

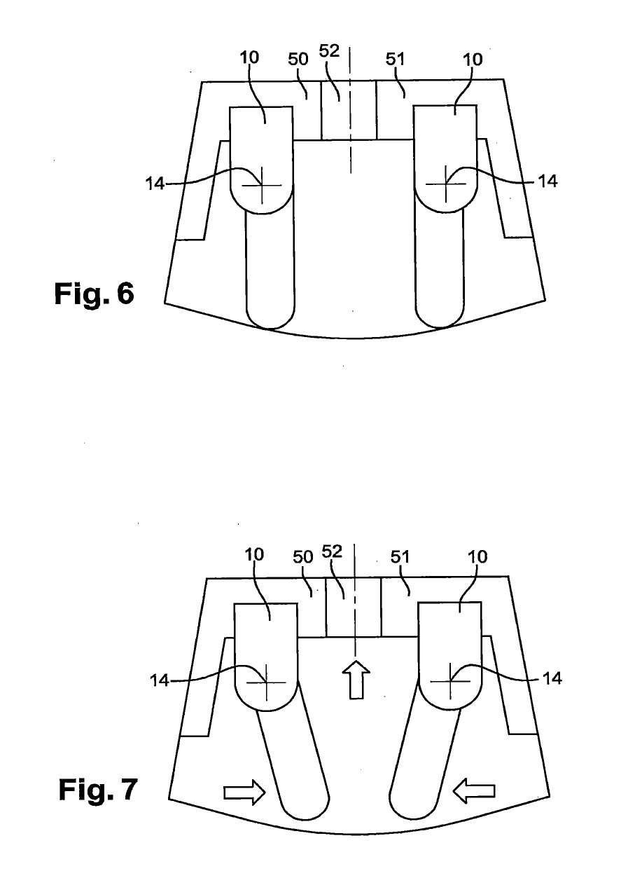

FIGS. 6 and 7 show a first embodiment where each of the two modules 50, 51 uses a motor-driven flap 10. This flap will be described in further detail hereafter. The flap has a swivel axis 14 formed substantially in the vicinity of the back wall of the internal chamber, said axis being parallel to the back wall of the internal chamber. The swiveling provides a tangential mechanization of the skin tissue, and may further be coupled with a vertical stimulation of said tissue due to the suction thereof into the internal chamber, when the massage head is connected to a depression source, the suction being shown by the upward arrow in FIG. 7.

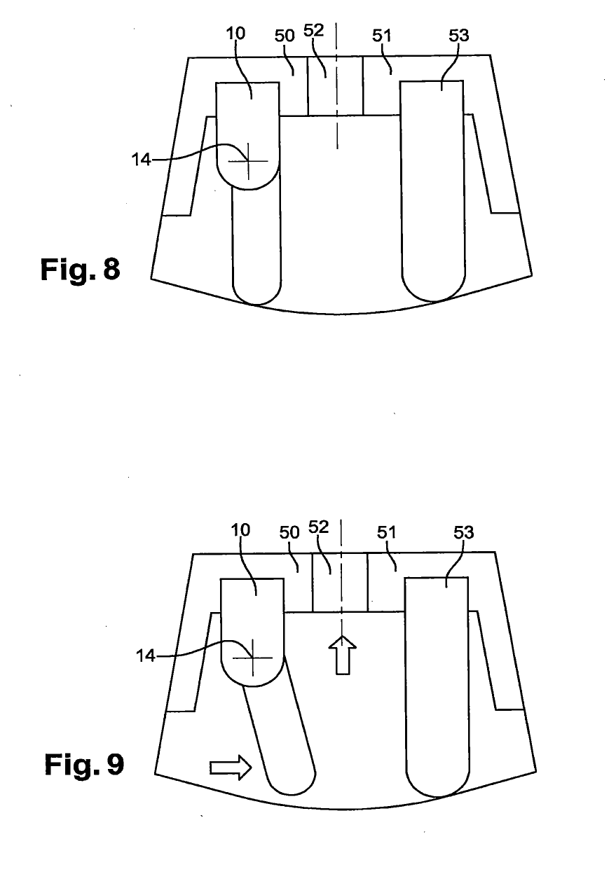

According to a second embodiment shown in relation with FIGS. 8 and 9, one of the functional elements is a motor-driven flap 10, and the other is simply a fixed flap or wall 53. This also provides a tangential mechanization of the skin. However, the use of such a wall enables to precisely target the skin tissue area to be mobilized, for example, the edge of a scar, the fixed wall being then positioned at the level of the area that the practitioner does not wish to mobilize.

In this embodiment, such a tangential mechanization may also be accompanied by a vertical stimulation in relation with the suction when the massage head is connected to a depression source, as described in relation with FIG. 3.

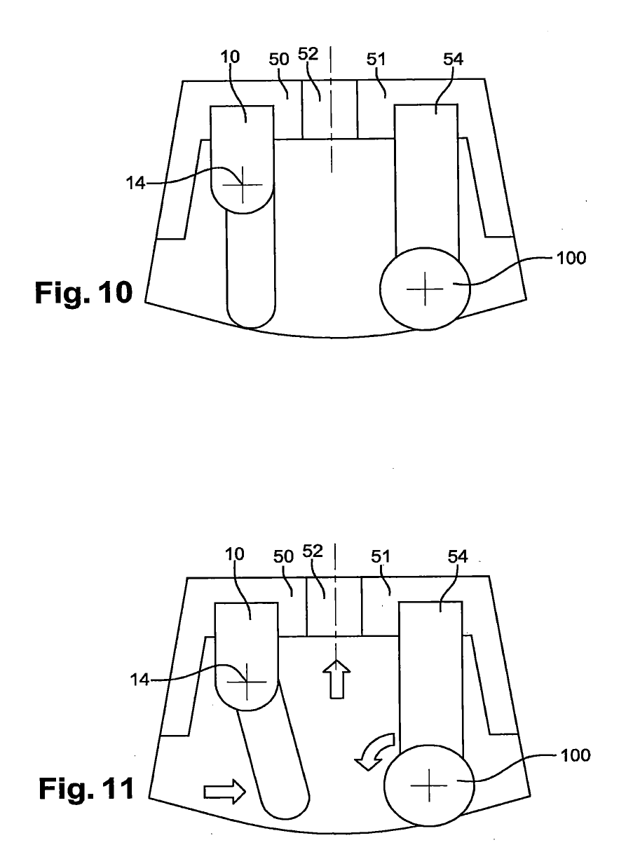

A third embodiment has been shown in relation with FIGS. 10 and 11, where the first functional element here again is a motor-driven flap 10, and the second functional element is a fixed motor-driven roller 100, that is, having a rotation axis which is not likely to vary, said roller being assembled at the lower end of a wall 54.

Thus, as shown in FIG. 11, in functional mode, a tangential mechanization is carried out while simultaneously ensuring the forming of the skinfold and promoting the displacement of the massage head on the patient's skin due to the rotation of motor-driven roller 100, the latter coming into contact with the patient's skin. Here again, this double action may be accompanied by a vertical stimulation by the depression created in the internal chamber of the massage head when it is connected to a depression source.

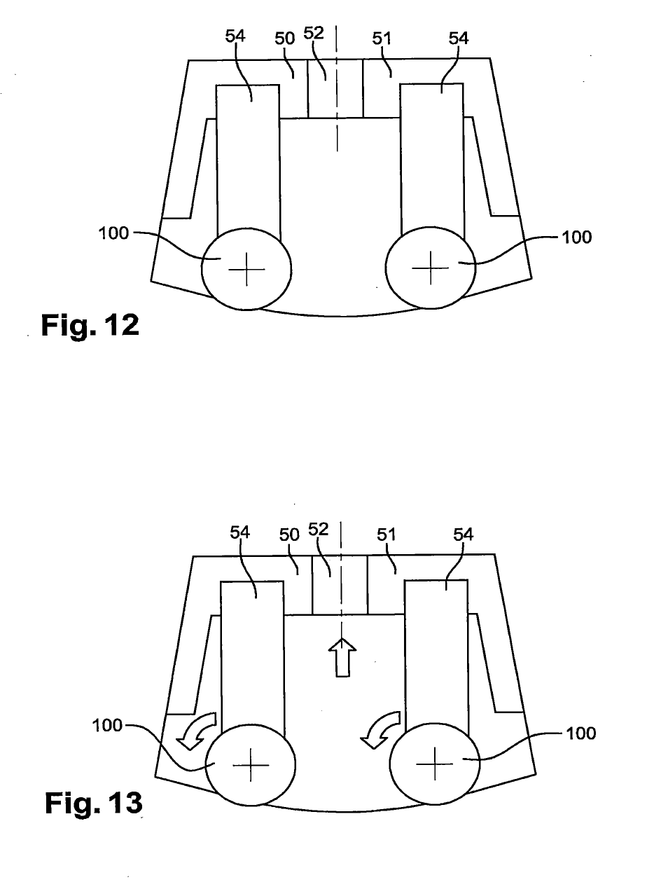

A fourth embodiment of this technology has been shown in relation with FIGS. 12 and 13. In this embodiment, the functional elements both are a fixed motor-driven roller 100, that is, as reminded hereabove, having a fixed rotation axis with respect to the internal chamber of the massage head. FIG. 13 shows the functional elements in motion, and particularly the rotation of the two motor-driven rollers 100 which promote the forming of the skinfold and the displacement of the massage head when the latter is in contact with the patient's skin. Here again, it is possible to optimize the vertical stimulation by the creating of a depression within the internal massage chamber when it is connected to a depression source.

Although the described example illustrates the rotation of two rollers in the same direction, it is quite possible for said rollers to also rotate in the same direction, but the opposite way around, or even for both rollers to have antagonistic rotations. Actually, and since each of the rollers has an independent motorization, allowing a different rotation speed of said rollers with respect to each other, all sorts of possible skin treatments may be carried out, including in-depth tissue mobilization, in addition to the possibility of treating fragile or severely damaged skins (persons burned to the third degree), by providing a controlled management of the forming of the skinfold in combination with a mild suction.

The following treatments can thus be carried out:

so-called “peeling” treatments, promoting skin exfoliation operations (the two rollers then rotate the opposite way around),

skin “stretching” treatments (the two rollers rotate the same way around and tend to oppose the forming of the skinfold);

amplified skin exercise treatments (the two rollers rotate the same way around, but with different rotation speeds, the upstream roller rotating with a greater rotation speed than the downstream roller).

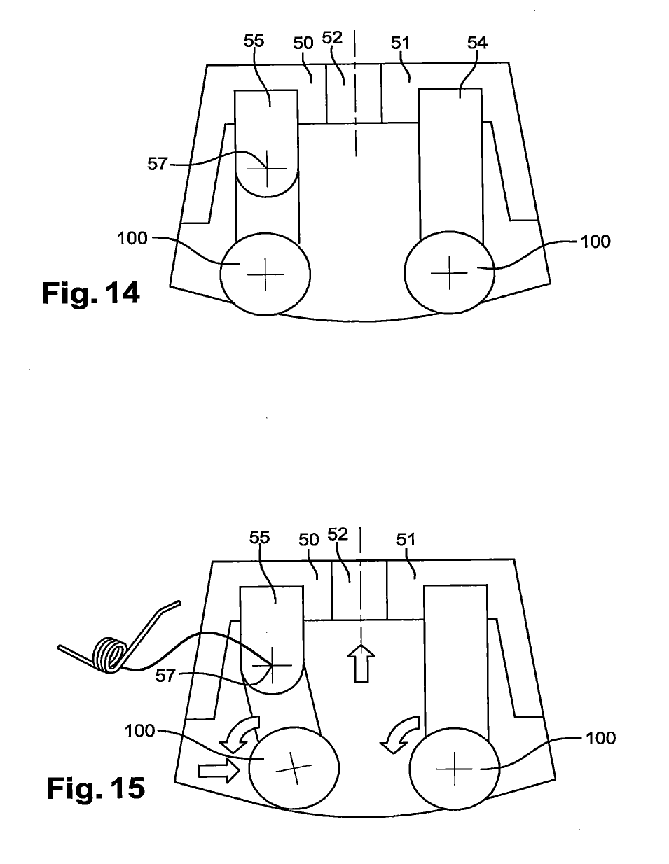

A fifth embodiment has been shown in relation with FIGS. 14 and 15, where:

the first functional element is formed of a mobile motor-driven roller, that is, assembled at the lower end of a wall 55, the latter being capable of pivoting around a swivel axis 57 formed in the vicinity of the bottom of said internal chamber and parallel to said bottom, and

the second functional element is a fixed motor-driven roller 100.

The pivoting of the mobile motor-driven roller occurs only due to the depression generated within the internal chamber. The wall having said roller mounted at its end is provided at the level of its swivel axis with a spring 56, generating, by default, that is, in the absence of suction, the returning of said wall to its initial position, such as shown in FIG. 14, where it extends substantially perpendicularly to the back wall of the internal chamber.

In this embodiment, in operation, in addition to the skinfold forming, the tangential stimulation is provided simultaneously to the displacement of the massage head on the patient's skin. At the same time, a vertical stimulation is exerted when the depression is created within the internal chamber.

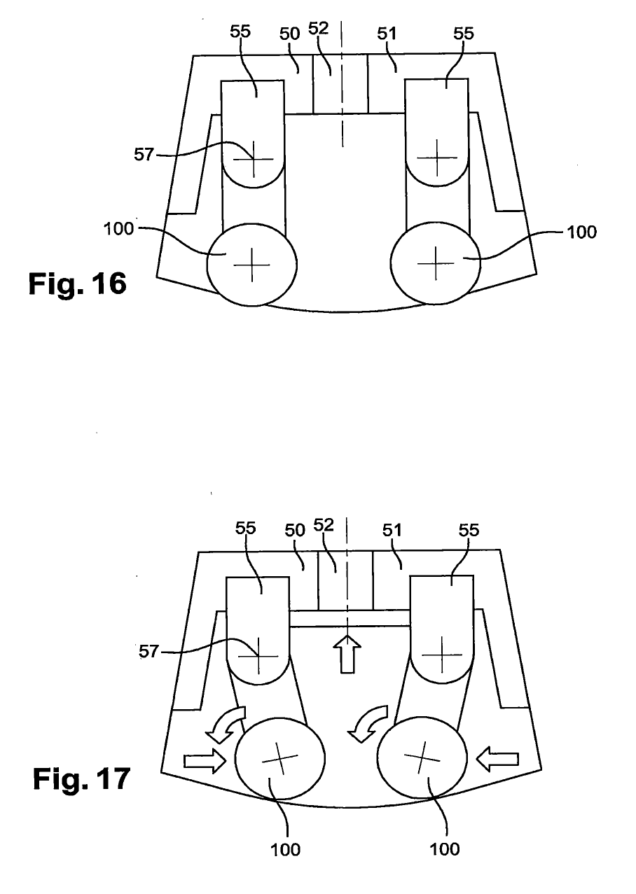

Finally, a sixth embodiment where the functional elements are both formed of a mobile motor-driven roller enabling to carry out the so-called subdermal massage technique has been shown in relation avec FIGS. 16 and 17.

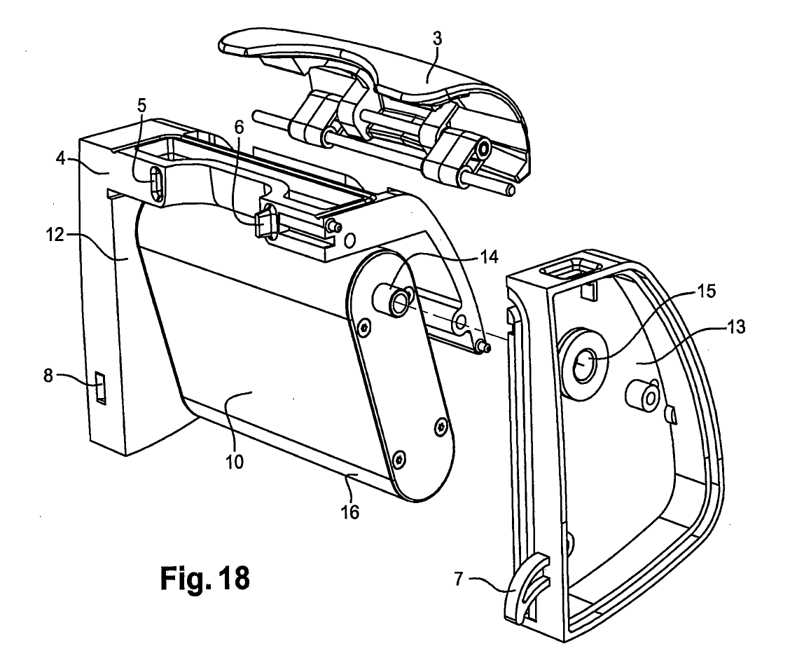

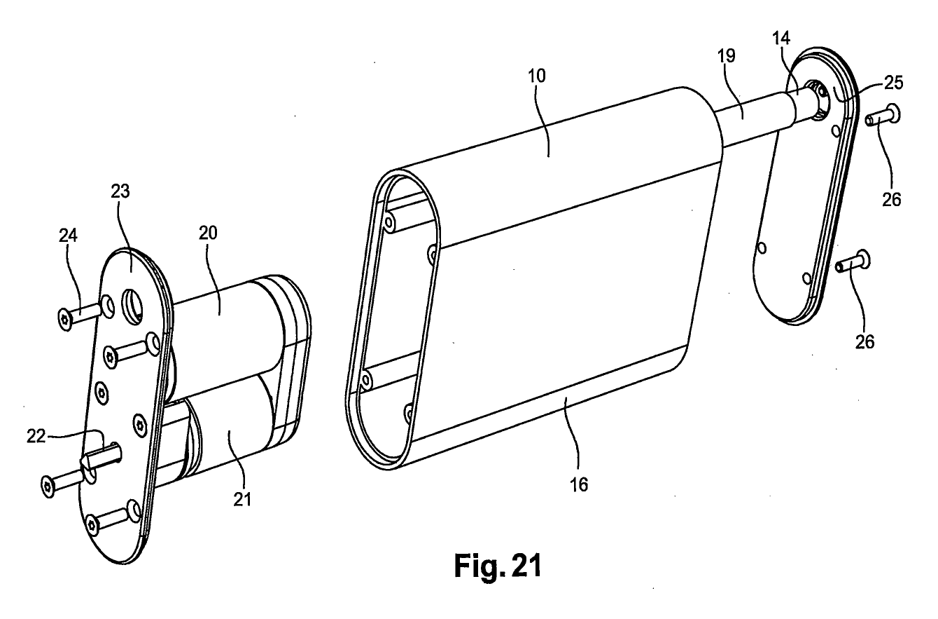

Motor-driven flap 10 implemented in the first three above-described embodiments will be briefly described in relation with FIGS. 18 to 21, it being reminded that the massage head using such a flap is the object of a patent application filed at the same time as the present application.

Thus, flap 10 is hinged in the vicinity of its upper end on lateral walls 12 and 13 defining the massage head, in the case in point belonging to the modules. To achieve this, flap 10 comprises a swivel axis 14, having its two ends received in a housing 15 formed at the level of each of the two lateral walls 12 and 13.

Flap 10 has a height substantially corresponding to that of the internal chamber defined by the massage head. It however slightly protrudes beyond the lower end of the lateral walls to optimize the pinching action.

Flap 10 has a rounded lower edge 16, advantageously coated with a material capable of optimizing the friction and, as a corollary, the pinching action when the massage head is in contact with the patient's skin.

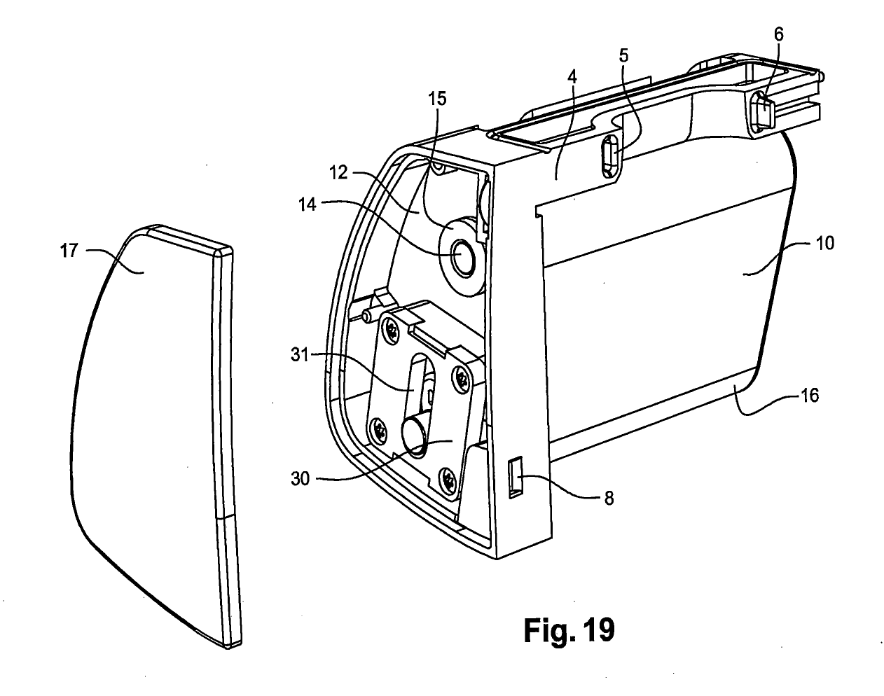

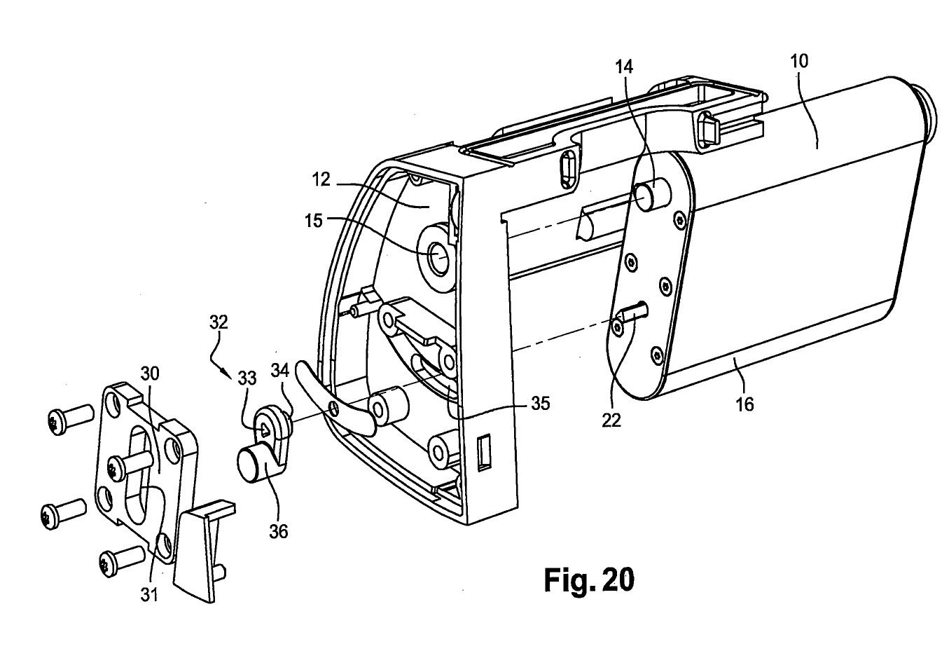

Lateral walls 12 and 13 have an internal volume enabling to receive, in particular, a cam race as illustrated in FIGS. 19 and 20. This volume is closed by a plate 17 (see FIG. 19) to protect the elements contained in said volumes.

FIG. 20 shows an exploded view of flap 10. It has a race-track shaped transverse cross-section. The volume thus defined receives a motor 20 actuating a gear reducer 21, reference 22 designating the output shaft of reducer 21. Actually, the couple formed of motor 20 and reducer 21 is fastened to a lateral plate 23, for example secured by means of screws 24 to one of the walls of flap 10. Another plate 25 closes the other wall of the flap, also fastened thereto by means of screws 26.

FIG. 19 shows a first view of lateral wall 12 integrating mechanical elements capable of allowing, in cooperation with geared motor 20, 21, the pivoting of flap 10. More specifically, FIG. 19 shows a cam race 30 here formed of a rectilinear port 31.

FIG. 20 more specifically shows the different mechanical elements allowing the pivoting of said flap 10. Thus, output shaft 22 of reducer 21, in the case in point having a triangular cross-section, is received in an opening of matching shape 33 formed within a cam 32. Cam 32 is actually formed of two cylinders, respectively 34 and 36, separated from each other by a linear portion.

Cylinder 36 cooperates with previously-described rectilinear port 31.

It should thus be understood that when reducer 21, actuated by motor 20, rotates output shaft 22, it generates the rotation of cam 32. Due to the cooperation thereof with cam race 31, the rotation of cam 32 causes the relative displacement of the lower end of flap 10, in the form of a pivoting thereof around its swivel axis 14. This thus ensures the mobilizing of flap 10 which pivots around its swivel axis 14 in motor-driven fashion.

As a corollary, the electric power supply of motor 20 is provided by means of an electronic board, advantageously integrated in the volume defined by lateral wall 13. This power supply may however be achieved by any known means.

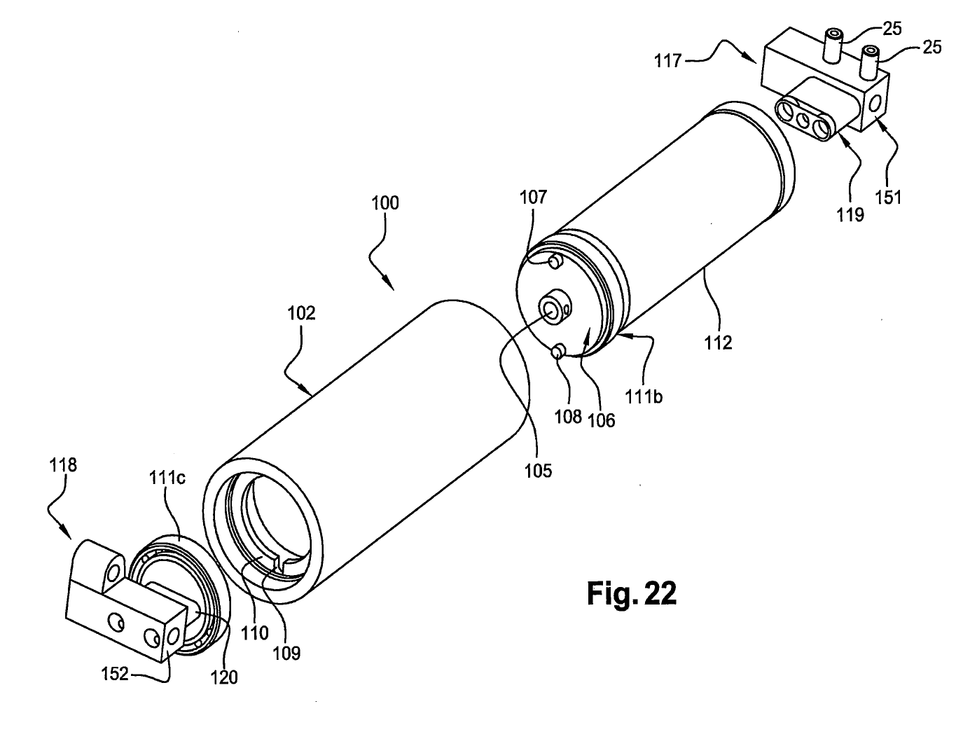

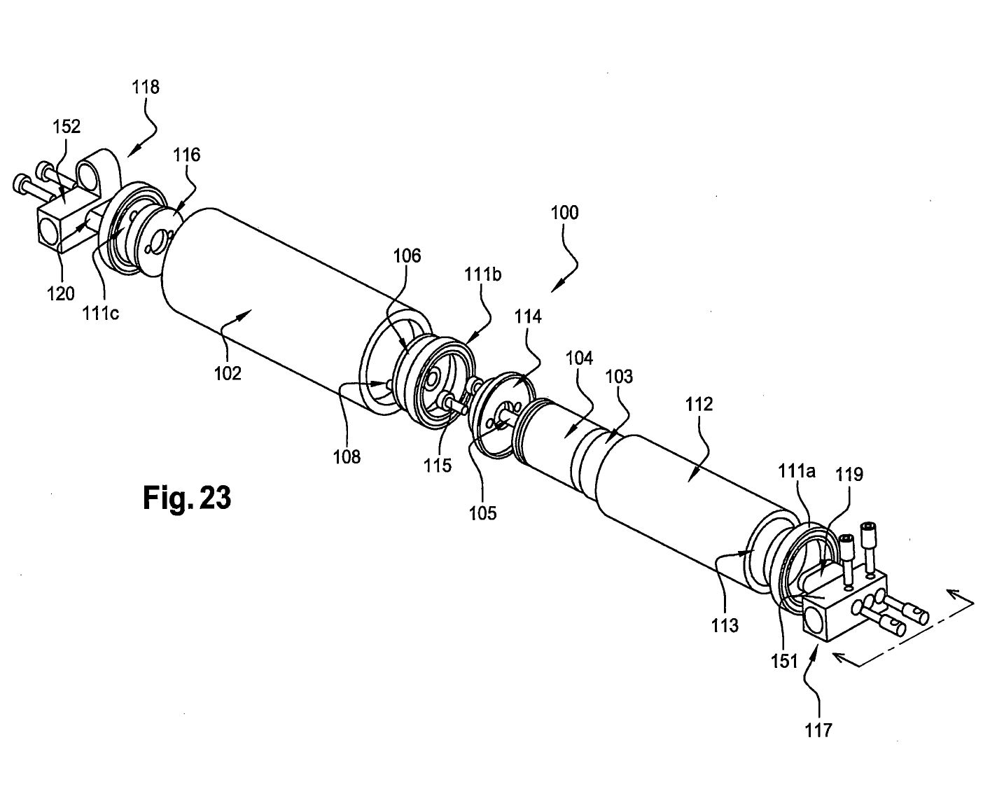

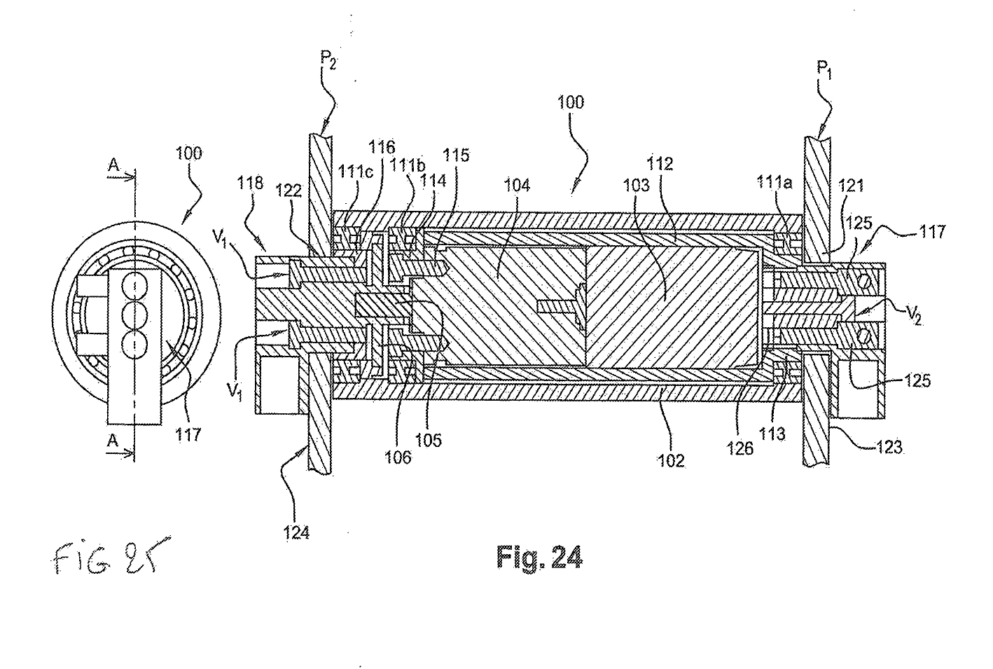

The motor-driven roller described hereabove in relation with FIGS. 22 to 25 is described in document EP 1 286 642. Mostly, the positive rotating of the roller is obtained via a geared reducer fixedly assembled within said roller and having its output shaft comprising means of coupling to said roller.

The roller designated with general reference numeral 100 is essentially formed of a cylindrical sleeve 102, which forms the active element in contact with the patient to be treated. The diameter and the length of cylindrical sleeve 102 are a function of the type of apparatus which is desired to be formed.

As an indication, sleeve 102 may have an outer diameter in the range from 20 to 30 millimeters for a length which may be in the range from 60 to 70 millimeters.

Of course, it may be envisaged to form rollers having smaller or greater dimensions, and this, according to the surface of the areas to be treated. It may be envisaged to have rollers of different diameters, or even to form apparatuses comprising more than two rollers, for example, a central motor-driven roller having two rollers of smaller diameter or of equal diameter arranged on either side thereof, to form two skinfolds.

Sleeve 102 may have a smooth external surface or, on the contrary, have a surface which may exhibit asperities or a relief according to the treatments to be performed.

Such a sleeve may be covered with a removable sheath, having a hygienic function and/or used as a support for a treatment product.

The rotating of sleeve 102 is obtained via a motor 103—reducer 104, fixedly assembled coaxially inside of said sleeve 102.

A conventional geared motor, powered with low-voltage D.C. current, 6 volts, for example, or also a brushless motor provided with an encoder to make the rotation speed control more accurate, may be used as a geared motor.

Output shaft 105 of the geared motor supports means of coupling with said sleeve 102, which means are formed of a disk or plate 106 fastened to shaft 105, the fastening being for example obtained by gluing. Disk 106 comprises two diametrically opposite lugs 107, 108, which lugs fit into corresponding recesses 109 (a single one being shown in FIG. 22), formed in an internal ring 110 of sleeve 102.

Accordingly, when geared motor 103, 104 is powered, output shaft 105 rotates disk 106, which, in turn, rotates sleeve 102.

The rotating of sleeve 102 around the geared motor assembly is obtained by mounting it on roller bearings 111a, 111b, 111c.

Roller bearings 111a, 111b are assembled on either side of the geared motor on fixed bearings 113, 114. To ensure the insulation, geared motor assembly 103, 104 is surrounded with a tube 112, for example, made of aluminum, rigidly attached to the motor body 103. The end bearing 113 is in this case formed by a seating formed at the end of tube 112, said tube thus forming not only an insulating cage, but being used as a support for end peripheral roller bearing 111a.

Roller bearing 111b is mounted on a bearing 114 formed by a flange fixed via screws 115 to the casing of reducer 104, thus immobilizing the latter and allowing the passage of shaft 105 of the reducer.

Finally, third roller bearing 111c is mounted against internal ring 110 of driving plate 106 supporting studs 107, 108, and this, via a fixed bearing 116.

Such a design provides an assembly having its end surfaces comprising no raised element, the outermost edges of sleeve 102, which thus appear in the form of a smooth planar ring, being capable of coming in sliding bearing relation against the internal surfaces of the lateral walls of the internal chamber of the massage head.

The fastening of the roller between the lateral walls of the chamber is obtained via removable connection blocks, designated with general reference numerals 117, 118. Each block comprises a proper connection guide 119, 120, of oblong shape, capable of passing through ports 121, 122 provided on each lateral wall to fit into complementary areas provided at each end of bearings 113, 116 of roller 100.

Each bearing connection guide 119, 120 is associated, for example, via screws, with two blocks 151, 152 bearing against outer surface 123, 124 of each lateral wall P1, P2.

Block 118 is secured by means of two screws V1 arranged on either side of the rotation shaft and, for block 119, via a single screw V2 secured in the rotation shaft.

Block 117 supports electric connections 125 to connection tabs 126 provided on the motor, as well as to the additional means enabling to control the different functions provided by the apparatus, that is, particularly:

setting the speed and the rotation direction of the motor-driven roller;

periodically and temporarily inverting the rotation direction of the roller;

controlling the pressure exerted by the roller against the formed skinfold.

Electric connections 125 are connected to the general control circuit by means of flexible connections capable of following the possible displacements that the roller can receive.

The advantages of the presently described embodiments in terms of modularity, on the one hand, and of multiplicity of the treatments capable of being applied to a patient's skin, on the other hand have thus been demonstrated. These advantages are further enhanced by the very simple character of the modularity of the massage head, which enables the practitioner to choose the tool that he/she intends to use by simple change of modules instead of the multiplicity of massage heads which had to be available to date.

This results in a simplicity of use and in a cost reduction.

1. A massage head comprising a casing forming an internal chamber defined by a back wall, two lateral walls, and two transverse walls, and open on its surface opposite to the back wall, and having a skinfold formed therein when the head is applied to a patient's skin:
wherein said head is formed of two modules fitted with means capable of enabling to reversibly fasten said two modules to each other, and
wherein each of said modules integrates a functional element, defining one of the transverse walls of the internal chamber.

2. The massage head of claim 1, wherein at least one of the functional elements fitting each of the modules is active.

3. The massage head of claim 2, wherein the functional element is a flap, said flap being hinged in the vicinity of an upper end on the lateral walls fitting the module and the pivoting movement of said flap being obtained by means of a geared motor fixedly assembled within said flap, an output shaft of said motor rotating a cam, received in a cam race fastened to one of said lateral walls of the module.

4. The massage head of claim 2, wherein the functional element is a motor-driven roller, positively rotated, the rotating being obtained by means of a geared motor fixedly assembled inside of the roller, an output shaft of said motor comprising means for coupling to said roller.

5. The massage head of claim 1, wherein one of the functional elements is a fixed flap or wall.

6. The massage head of claim 1, wherein one of the functional elements is formed of a roller simply assembly to freely rotate, with a fixed center-to-center distance.

7. The massage head of claim 1, wherein said modules define, when they are reversibly fastened to each other, the back wall of the internal chamber and form an opening into which a suction circuit, connected to the massage device having the massage head assembled thereon, emerges.

8. A massage device comprising:
a massage head comprising a casing forming an internal chamber defined by a back wall, two lateral walls, and two transverse walls, and open on its surface opposite to the back wall, and having a skinfold formed therein when the head is applied to a patient's skin, wherein said head is formed of two modules fitted with means capable of enabling to reversibly fasten said two modules to each other, and wherein each of said modules integrates a functional element, defining one of the transverse walls of the internal chamber; and
an electric power source capable of actuating a geared motor of at least one of the functional elements.

9. The massage device of claim 8, further comprising a vacuum or depression source associated with the massage head, and emerging into the massage head.

10. The massage device of claim 8, wherein at least one of the functional elements fitting each of the modules is active.

11. The massage device of claim 10, wherein the functional element is a flap, said flap being hinged in the vicinity of an upper end on the lateral walls fitting the module and the pivoting movement of said flap being obtained by means of a geared motor fixedly assembled within said flap, an output shaft of said motor rotating a cam, received in a cam race fastened to one of said lateral walls of the module.

12. The massage device of claim 10, wherein the functional element is a motor-driven roller, positively rotated, the rotating being obtained by means of a geared motor fixedly assembled inside of the roller, an output shaft of said motor comprising means for coupling to said roller.

13. The massage device of claim 8, wherein one of the functional elements is a fixed flap or wall.

14. The massage device of claim 8, wherein one of the functional elements is formed of a roller simply assembly to freely rotate, with a fixed center-to-center distance.

15. The massage device of claim 8, wherein said modules define, when they are reversibly fastened to each other, the back wall of the internal chamber and form an opening into which a suction circuit, connected to the massage device having the massage head assembled thereon, emerges.

16. The massage device of claim 10, further comprising a vacuum or depression source associated with the massage head, and emerging into the massage head.

17. The massage device of claim 11, further comprising a vacuum or depression source associated with the massage head, and emerging into the massage head.

18. The massage device of claim 12, further comprising a vacuum or depression source associated with the massage head, and emerging into the massage head.

19. The massage device of claim 13, further comprising a vacuum or depression source associated with the massage head, and emerging into the massage head.

20. The massage device of claim 14, further comprising a vacuum or depression source associated with the massage head, and emerging into the massage head.

21. The massage device of claim 15, further comprising a vacuum or depression source associated with the massage head, and emerging into the massage head.
